(19) United States
(12) Patent Application Publication
(10) Pub. No.: US 2010/0017712 A1
(43) Pub. Date: Jan. 21, 2010

(54) Mobile Terminal Device, Language Selection Method In Mobile Terminal Device

(75) Inventor: Takefumi Kondo, Kanagawa-ken (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/280,955

(22) PCT Filed: Feb. 27, 2007
(86) PCT No.: PCT/JP2007/053640

§ 371 Date: Aug. 24, 2009

(30) Foreign Application Priority Data
Feb. 27, 2006 (JP) 2006-049841

(51) Int. Cl. G06F 3/048; G06F 17/20

(52) U.S. Cl. 715/709; 704/8; 715/810

(57) ABSTRACT

A mobile terminal device includes: a display unit having a guide display region;

operation keys; and a control unit, wherein the mobile terminal device is configured to allow a selection of a language from application languages, to carry out various guides using a selected language, and to display a function assigned to at least one of the operation keys in the guide display region of the display unit, and the control unit is configured to assign a language switching accepting function for accepting a switching operation to a non-selected language while a stand-by screen is displayed to at least one of the operation keys, and to display a guide image of a language switching unit, which corresponds to the at least one of the operation keys, and which is expressed in the non-selected language, in the guide display region of the display unit.

### TECHNICAL FIELD

The present invention relates to a mobile terminal device and a language selection method for a mobile terminal device.

The present application claims priority on Japanese patent application No. 2006-49841 filed Feb. 27, 2006, of which contents are incorporated herein by reference.

### BACKGROUND ART

A conventional mobile terminal device includes a display unit and an operation unit, and allows desired operations by displaying various menus on the display unit, and by accepting selections in the various menus. As disclosed in patent document 1, many of such conventional mobile terminal devices allow selection of a language from multiple kinds for displaying the various menus on the display unit. In general in such a conventional technology, a screen for switching a language can only be reached by sequentially opening the layers of the various menus displayed on the display unit.
Patent Document 1: Unexamined Japanese Patent Application, First Publication No. 2005-244278

### DISCLOSURE OF INVENTION

### Problems to be Solved by the Invention

In a conventional mobile terminal device, it is possible to select a language for expressing various menus on a display unit from, for example, Japanese and English. However, in a case in which Japanese has been selected and the various menus are expressed in Japanese, a user, who cannot read Japanese at all, and wishes to carry out switching into English, cannot understand the various menus expressed in Japanese. Therefore, the user cannot reach a language selection screen which can be reached by sequentially opening the layers of the various menus, and the user cannot carry out switching of the language.

In other words, in a conventional mobile terminal device, it is very difficult for a user to carry out switching into a language which is understandable for the user if the selected language is a language which is not understandable for the user, even if the mobile terminal device allows selection of a language which is understandable for a user.

The present invention was made in view of the above circumstances, and an object thereof is, in a mobile terminal device which allows selection of an application language from various languages, to enable a user to easily carry out switching of a language into another one even if the user cannot understand the currently selected language.

### Means for Solving the Problem

In order to solve the above problem, a first aspect of the present invention is a mobile terminal device including: a display unit having a guide display region; operation keys; and a control unit, wherein the mobile terminal device is configured to allow a selection of a language from application languages, to carry out various guides using a selected language, and to display a function assigned to at least one of the operation keys in the guide display region of the display unit, and the control unit is configured to assign a language switching accepting function for accepting a switching operation to a non-selected language while a stand-by screen is displayed to at least one of the operation keys, and to display a guide image of a language switching unit, which corresponds to the at least one of the operation keys, and which is expressed in the non-selected language, in the guide display region of the display unit.

Moreover, as a second aspect of the present invention, the above mobile terminal device may further include a storage unit which is a nonvolatile memory, wherein the control unit may be configured to cause the storage unit to store an acceptance result obtained by the language switching accepting function, to read out the acceptance result from the storage unit upon starting of power supply, and to carry out various guides using a language which matches the acceptance result.

Moreover, as a third aspect of the present invention, in the above mobile terminal device, the control unit may be configured to assign language switching accepting functions for accepting different switching operations to the operation keys, respectively.

Furthermore, a fourth aspect of the present invention is a language selection method for a mobile terminal device which includes a display unit having a guide display region, operation keys, and a control unit, and in which a selection of a language from application languages is allowed, the method including: a step of assigning a language switching accepting function for accepting a switching operation to a non-selected language while a stand-by screen is displayed to at least one of the operation keys; and a step of displaying a guide image of a language switching unit, which corresponds to the at least one of the operation keys, and which is expressed in the non-selected language, in the guide display region of the display unit.

### Effects of the Invention

According to the present invention, a switching operation of a language is accepted by a stand-by screen which is displayed immediately after starting of power supply and is easily displayed thereafter, and an image of a language switching unit, which corresponds to the operation key that accepts the operation, the operation key being a language switching unit, is expressed in a language which is not currently selected. Therefore, it is possible even for a user who cannot read the currently selected language to easily carry out switching of a language into another because the user can recognize the operation key that accepts the switching operation of a language if the user can read another language which is not currently selected, although the user cannot read the currently selected language.

### BRIEF DESCRIPTION OF THE DRAWINGS

FIG. 1 is a perspective view showing an exterior view of a mobile telephone according to an embodiment of the invention.

FIG. 2 is a block diagram showing a structure of the mobile telephone according to an embodiment of the invention.

FIG. 3 is a flowchart showing a flow of processing in relation to a language executed by the mobile telephone according to an embodiment of the invention.

FIG. 4A is a diagram showing an example of a screen displayed on a display unit according to an embodiment of the invention, in particular, the screen is a stand-by screen in a case in which Japanese is selected and a switching object language is English.

FIG. 4B is a diagram showing an example of a screen displayed on the display according to the embodiment of the invention, in particular, the screen is a stand-by screen in a case in which English is selected and a switching object language is Japanese.

### DESCRIPTION OF THE REFERENCE SYMBOLS

1: operation unit, 1a: numeric keypad, 1b and 1c: general purpose keys, 1d: combination key, 2: display unit, 3: display control unit, 4: radio unit, 5: telephone function unit, 6: storage unit (storage device), 7: control unit

### BEST MODE FOR CARRYING OUT THE INVENTION

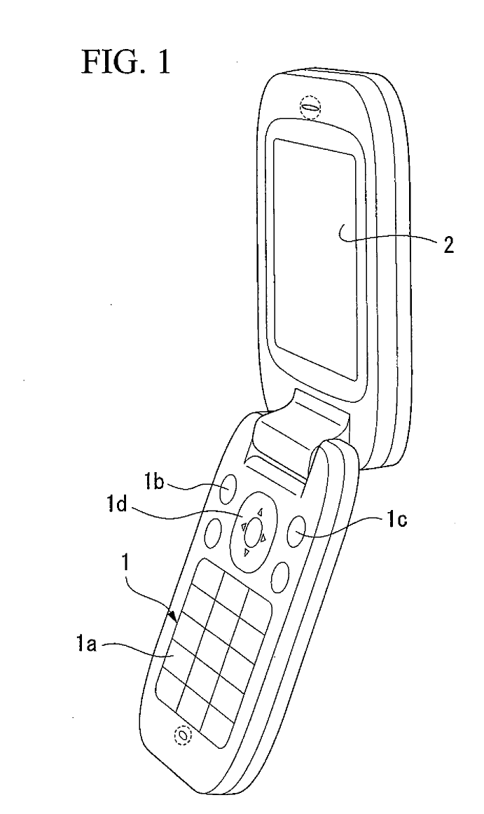

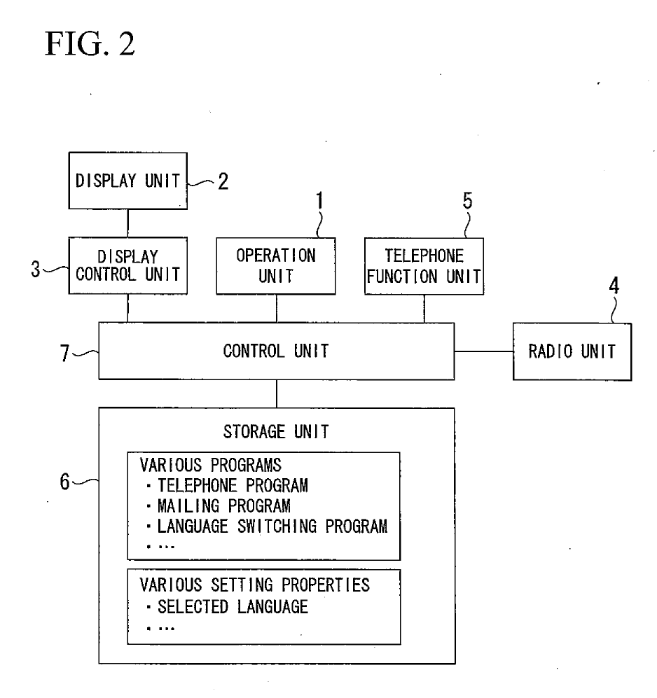

A mobile telephone, which is an embodiment of a mobile terminal device of the present invention, will be explained below with reference to the drawings. FIG. 1 is a perspective view showing an exterior view of the mobile telephone according to the embodiment. FIG. 2 is a block diagram showing a structure of the mobile telephone. The mobile telephone includes an operation unit 1, a display unit 2, a display control unit 3, a radio unit 4, a telephone function unit 5, a storage unit 6 (a storage device), and a control unit 7. The display control unit 3 and the control unit 7 constitute a controller.

The operation unit 1 includes multiple keys to which a user can apply operations, such as a numeric keypad 1a, general purpose keys 1b and 1c, and combination key 1d, accepts various operations from a user such as placing a phone call, transmitting e-mails, or switching of a selected language, and output signals to the control unit 7.

The general purpose keys 1b and 1c are disposed at the right and left ends of the upper portion of the operation unit 1, and respective functions corresponding to icons are assigned thereto when the icons are displayed at both ends of the bottom portion of the display unit 2.

The combination key 1d includes a key indicating upper, lower, right, and left directions, and another key located at the center thereof, and respective functions corresponding to icons are assigned thereto when one of the icons is displayed at the middle of the bottom portion of the display unit 2.

The display unit 2 is a liquid crystal panel or the like, and displays various images based on image signals input from the display control unit 3.

Under the control of the control unit 7, the display control unit 3 generates image signals for the images to be displayed on the display unit 2, and outputs the image signals to the display unit 2.

Under the control of the control unit 7, the radio unit 4 establishes a radio communication line with a base station, and carries out information communications therewith.

The telephone function unit 5 includes a microphone, a speaker, etc., corrects user's voice, and emits talker's voice.

The storage unit 6 stores various programs to be executed by the control unit 7, such as a telephone program, an e-mail program, a stand-by program, and a language switching program, as well as various setting properties.

Here, in this mobile telephone, it is made possible to select a language from multiple languages (e.g., Japanese and English), which is used for expressing the menus or icons displayed on the display unit 2.

The storage unit 6 stores, as one of the setting properties, a language which is initially set, or a language selected by the user.

The control unit 7 includes, such as, a CPU (Central Processing Unit) which controls the entire operations of this mobile telephone based on the control programs and the various data for control operations which are stored in the internal memory, and various input/output interface circuits for sending signals to and receiving signals from the other units.

The control unit 7 switches the language to a selected one, which is used for expressing the menus and icons on the display unit 2, by executing the language switching program stored in the storage unit 6.

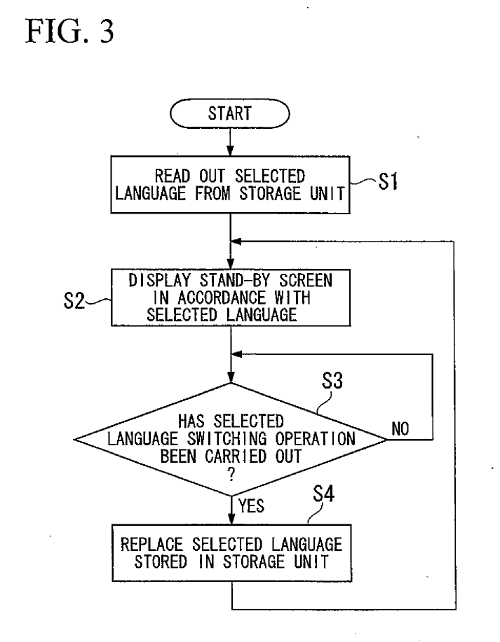

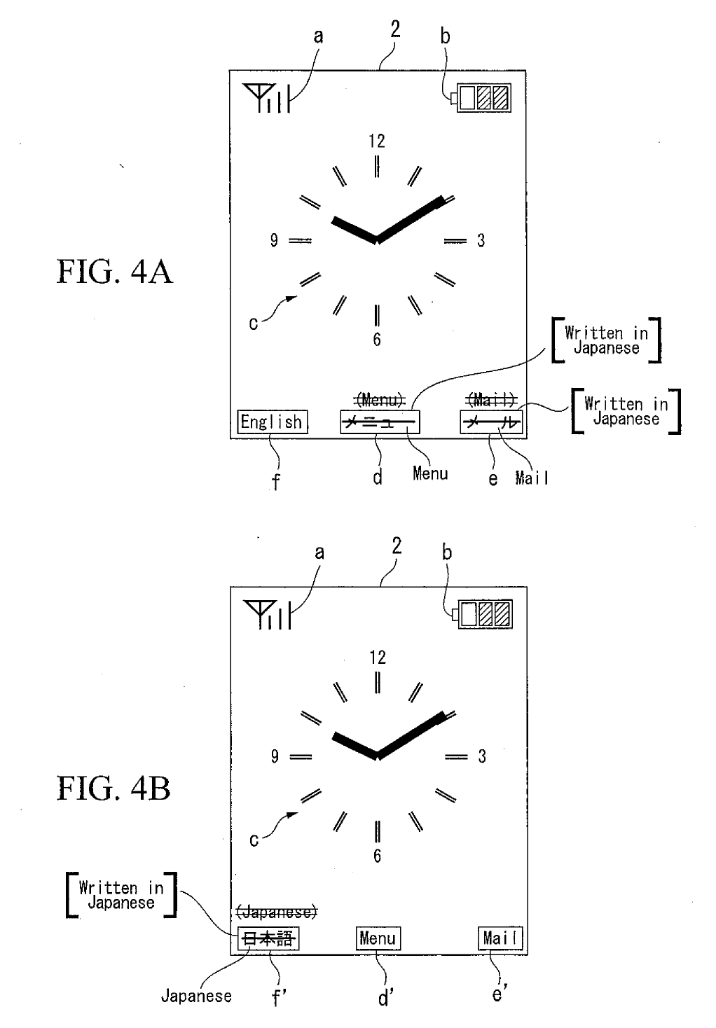

FIG. 3 is a flowchart showing a flow of processing in relation to a language executed by the mobile telephone. FIGS. 4A and 4B show examples of screens displayed on the display unit 2. When the power of the mobile telephone is turned on, the control unit 7 first reads out the language that is currently selected from the storage unit 6 (step S1), and controls the display control unit 3 so as to display a stand-by screen using the language currently selected (step S2).

If, in step S1, the language stored in the storage unit 6 and currently selected is Japanese, and non-selected language, i.e., a switching object language, is English, the stand-by screen shown in FIG. 4A is displayed in step S2. In this stand-by screen, images a and b respectively indicating radio wave intensity and state of charge of a battery, as well as an image c of a clock which is set in advance by the user so as to be displayed on the stand-by screen, and icons d, e, and f for guiding the functions assigned to the combination key 1d and the general purpose keys 1b and 1c, which are included in the operation keys of the operation unit 1, and for guiding the positions of these keys are displayed in a guide display region located at the bottom of the display unit 2.

In the stand-by screen shown in FIG. 4A, a function accepting a command operation for displaying various menus on the display unit 2 is assigned to the combination key 1d, and the icon d shows the position of the combination key 1d and the functions assigned to the combination key 1d.

Moreover, a function accepting a command operation for starting the e-mail program is assigned to the right general purpose key 1c, and the icon e shows the position of the general purpose key 1c and the functions assigned to the general purpose key 1c.

Furthermore, a function accepting a command operation for switching the selected language from Japanese to English is assigned to the left general purpose key 1b which constitutes a language switching unit, and the icon f shows, as the guide image of the language switching unit, the position of the general purpose key 1b and the functions assigned to the general purpose key 1b.

In a case in which the image shown in FIG. 4A is set as a stand-by screen, the control unit 7 controls the display control unit 3 so that various guides are expressed in Japanese in images displayed on the display unit 2 when any of the keys in the operation unit 1 other than the general purpose key 1b are operated.

The icon f, which is the guide image of the language switching unit, is expressed in English so that a user who cannot read Japanese can understand that the function accepting a command operation for switching the selected language from Japanese to English is assigned to the general purpose key 1b. When the general purpose key 1b which is the language switching unit and corresponds to the icon f is operated, a signal indicating that a language selection switching operation is accepted is output from the general purpose key 1b to the control unit 7 (“Yes” in step S3), the control unit 7 replaces the selected language stored in the storage unit 6 with English (step S4), and the control unit 7 controls the display control unit 3, in step S2, so that a stand-by screen corresponding to the selected language is displayed on the display unit 2. Thus, the stand-by screen shown in FIG. 4B is displayed on the display unit 2.

In FIG. 4B, the icons d, e, and f, which guide the functions assigned to the combination key 1d and the general purpose keys 1b and 1c and positions thereof, shown in FIG. 4A are replaced with the icons d′, e′, and f′. More specifically, the icon d′ corresponding to the function accepting a command operation for displaying various menus on the display unit 2 which is assigned to the combination key 1d, and the icon e′ corresponding to the function accepting a command operation for starting the e-mail program which is assigned to the right general purpose key 1c are expressed in English. Moreover, the function assigned to the left general purpose key 1b is a function accepting a command operation for switching the selected language from English to Japanese, and the icon f′ corresponding to this function is expressed in Japanese.

In a case in which the image shown in FIG. 4B is set as a stand-by screen, the control unit 7 controls the display control unit 3 so that various guides are expressed in Japanese in images displayed on the display unit 2 when any of the keys in the operation unit 1 other than the general purpose key 1b are operated.

The icon f′, which is the guide image of the language switching unit, is expressed in Japanese so that a user who cannot read English can understand that the function accepting a command operation for switching the selected language from English to Japanese is assigned to the general purpose key 1b. When the general purpose key 1b which is the language switching unit and corresponds to the icon f′ is operated, a signal indicating that a language selection switching operation is accepted is output from the general purpose key 1b to the control unit 7 (“Yes” in step S3), the control unit 7 replaces the selected language stored in the storage unit 6 with Japanese (step S4), and the control unit 7 controls the display control unit 3, in step S2, so that a stand-by screen corresponding to the selected language is displayed on the display unit 2.

In the mobile telephone, in a case in which the power supply is resumed after the power supply is shut off, the control unit 7 reads out the selected language stored in the storage unit 6, and controls the display control unit 3 so that a stand-by screen corresponding to the selection language is displayed on the display unit 2 every time the power supply is resumed. Therefore, the language setting once made is effective even after the power supply is shut off.

Note that, the description of the present embodiment was given taking, as an example, a two-language selection and switching between Japanese and English; however, this is not limited in an implementation, and the language may be others. Moreover, switching may be carried out among three or more languages. If switching is carried out among three or more languages, two or more languages other than the selected language are the switching object languages; therefore, the functions accepting the switching operations to the switching object languages may be respectively assigned to the two or more operation keys, and the icons corresponding to these functions to be displayed on the display unit 2 may be expressed in the switching object languages.

The preferred embodiment of the present invention has been described above; however, the present invention is not limited to this. It is possible to incorporate additions of elements, omissions, replacements, and other modifications without departing from the substance of the present invention. The present invention is not limited by the above description, and the invention is only limited by the appended claims.

1. A mobile terminal device comprising:
a display unit having a guide display region;
operation keys; and
a control unit, wherein
the mobile terminal device is configured to allow a selection of a language from application languages, to carry out various guides using a selected language, and to display a function assigned to at least one of the operation keys in the guide display region of the display unit, and
the control unit is configured to assign a language switching accepting function for accepting a switching operation to a non-selected language while a stand-by screen is displayed to at least one of the operation keys, and to display a guide image of a language switching unit, which corresponds to the at least one of the operation keys, and which is expressed in the non-selected language, in the guide display region of the display unit.

2. The mobile terminal device according to claim 1, further comprising a storage unit which is a nonvolatile memory, wherein
the control unit is configured to cause the storage unit to store an acceptance result obtained by the language switching accepting function, to read out the acceptance result from the storage unit upon starting of power supply, and to carry out various guides using a language which matches the acceptance result.

3. The mobile terminal device according to claim 1, wherein
the control unit is configured to assign language switching accepting functions for accepting different switching operations to the operation keys, respectively.

4. A language selection method for a mobile terminal device which includes a display unit having a guide display region, operation keys, and a control unit, and in which a selection of a language from application languages is allowed, the method comprising:
a step of assigning a language switching accepting function for accepting a switching operation to a non-selected language while a stand-by screen is displayed to at least one of the operation keys; and
a step of displaying a guide image of a language switching unit, which corresponds to the at least one of the operation keys, and which is expressed in the non-selected language, in the guide display region of the display unit.
